(19) United States
(12) Patent Application Publication
(10) Pub. No.: US 2019/0227486 A1
(43) Pub. Date: Jul. 25, 2019

(54) HEATER UNIT AND IMAGE FORMING APPARATUS

(71) Applicant: CANON KABUSHIKI KAISHA, Tokyo (JP)

(72) Inventor: Michihito Yamazaki, Tokyo (JP)

(21) Appl. No.: 16/256,381

(22) Filed: Jan. 24, 2019

(30) Foreign Application Priority Data
Jan. 25, 2018 (JP) 2018-010781

(51) Int. Cl. G03G 21/20; G03G 15/00

(52) U.S. Cl. CPC G03G 21/206; G03G 21/203; G03G 2221/1645; G03G 15/5045

(57) ABSTRACT

A heater unit is detachably attachable to an image forming apparatus, the image forming apparatus including an intake port configured to be provided in an exterior of a body of the image forming apparatus, and the heater unit includes:
a power plug configured to receive power from a commercial power supply;
a heater configured to generate heat by the power received from the power plug;
a fan configured to rotate by the power received from the power plug and blow air warmed by the heater; and
a screw hole configured to fix the heater unit to the image forming apparatus by a screw,
wherein the heater unit is configured to be mounted on the intake port so that an air flow generated by the fan of the heater unit flows into the intake port.

### BACKGROUND OF THE INVENTION

### Field of the Invention

The present invention relates to a heater unit detachably attachable to an image forming apparatus such as an electrophotographic copying machine or an electrophotographic printer.

### Description of the Related Art

In an electrophotographic image forming apparatus, an electrostatic latent image is developed as a toner image, the toner image is transferred to a recording material, and a resultant is output through a thermal fixing process. When such an image forming apparatus is operated, a temperature inside the image forming apparatus becomes higher than that of outside air due to heat generated by an operation or the like of a fixing apparatus or various motors.

However, for example, in the case where power is applied to the image forming apparatus immediately after heating is operated after the image forming apparatus is left in a state where heating is stopped in winter in a cold district, dew condensation may occur in the image forming apparatus due to warm air taken from an intake port of the image forming apparatus into the image forming apparatus. When image formation is performed in a state where a water droplet is attached to a photoreceptor due to this dew condensation, a surface of the photoreceptor or a toner is locally wetted, such that uniform charging or uniform toner coating becomes difficult, resulting in an image defect such as density unevenness.

On the other hand, an image forming apparatus described in Japanese Patent Laid-Open No. 2006-11329 is embedded with a heater for warming up a photoreceptor. This image forming apparatus removes dew condensation by heating the photoreceptor with the heater when it is determined that there is dew condensation.

However, when an image forming apparatus which does not have a dew condensation preventing heater or an image forming apparatus having a dew condensation preventing heater is installed in an environment where a temperature is lower than a temperature assumed in a design and temperature fluctuation is expected due to heating or the like, there is a risk that the dew condensation will occur.

### SUMMARY OF THE INVENTION

It is desirable to provide a heater unit which is detachably attachable to an image forming apparatus to suppress dew condensation.

A representative configuration of a heater unit according to the present invention to achieve the above object is

a heater unit detachably attachable to an image forming apparatus, the image forming apparatus including an image forming portion configured to form an image by transferring a toner image formed on a surface of a photoreceptor to a recording material, an intake port configured to be provided in an exterior of a body of the image forming apparatus, a duct configured to guide air taken in from the intake port to the surroundings of the photoreceptor, and a duct fan configured to generate an air flow for taking air from the intake port into the duct, the heater unit including:

a power plug configured to receive power from a commercial power supply;

a heater configured to generate heat by the power received from the power plug;

a fan configured to rotate by the power received from the power plug and blow air warmed by the heater; and

a screw hole configured to fix the heater unit to the image forming apparatus by a screw,

wherein the heater unit is configured to be mounted on the intake port so that an air flow generated by the fan of the heater unit flows into the intake port.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus;

FIG. 2 is a schematic diagram showing an arrangement relationship between a fan and a duct of the image forming apparatus;

FIG. 3 is graphs showing relationships between a temperature at a standard atmospheric pressure and an amount of water vapor contained in each atmosphere having a relative humidity of 100%, 80%, 60%, 40%, and 20%;

FIG. 4 is a perspective view of a heater unit viewed from an intake side;

FIG. 5 is a perspective view of the heater unit viewed from an exhaust side;

FIG. 6 is a view showing a mounted portion at which a heater unit is mounted on the image forming apparatus;

FIG. 7 shows schematic diagrams of a DIP switch;

FIG. 8 is a block diagram showing a system configuration of the heater unit;

FIG. 9 is a flowchart showing an operation flow of the heater unit;

FIG. 10 is a graph showing a relationship between a target temperature of an exhaust gas temperature and the latest temperature of outside air in the case where a mode M1 is selected;

FIG. 11 is a graph showing a relationship between a target temperature of an exhaust gas temperature and the latest temperature of outside air in the case where a mode M2 is selected;

FIG. 12 is a graph showing a relationship between a target temperature of an exhaust gas temperature and the latest temperature of outside air in the case where a mode M3 is selected;

FIG. 13 is a perspective view of the heater unit viewed from an exhaust side;

FIG. 14 is a view showing a mounted portion at which a heater unit is mounted on the image forming apparatus;

FIG. 15 is a flowchart showing an operation flow of the heater unit; and

FIG. 16 is a graph showing a relationship between a target temperature of a detected temperature of an environmental sensor and the latest temperature of outside air in the case where a mode M2 is selected.

### DESCRIPTION OF THE EMBODIMENTS

### First Embodiment

<Image Forming Apparatus>

Hereinafter, an overall configuration of an image forming apparatus on which a heater unit according to a first embodiment of the present invention is mounted will be described with reference to the drawings, together with an operation at the time of image formation. Dimensions, materials, shapes, relative arrangements, and the like of components described below are not intended to limit the scope of the present invention unless specifically stated otherwise.

The image forming apparatus A according to the present embodiment is an electrophotographic multifunction printer which transfers toners of four colors of yellow Y, magenta M, cyan C, and black K to an intermediate transfer belt, and then transfers an image to a sheet as a recording material to form the image. In the following description, Y, M, C, and K are added as subscripts to members using the toners of the respective colors, but since configurations or operations of the respective members are substantially the same as one another except that colors of the toners used in the respective members are different from one another, the subscripts are appropriately omitted unless it is necessary to distinguish the configurations or the operations of the respective members from one another.

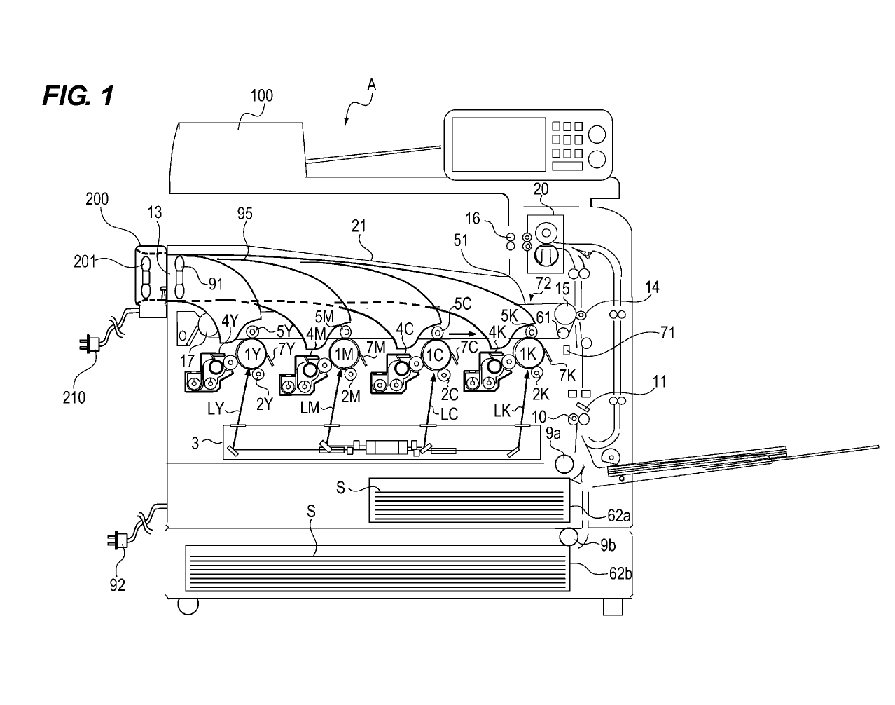

As shown in FIG. 1, an image forming apparatus A includes an image forming portion which forms an image by transferring a toner image to a sheet, a sheet feeding portion which supplies the sheet toward the image forming portion, and a fixing portion which fixes the toner image to the sheet. In the image forming apparatus A, power is supplied by connecting a power plug 92 to an outlet of a commercial power supply.

The image forming portion includes a photosensitive drum 1: 1Y, 1M, 1C, and 1K, a charging roller 2: 2Y, 2M, 2C, and 2K which charges a surface of the photosensitive drum 1: 1Y, 1M, 1C, and 1K, and a developing device 4: 4Y, 4M, 4C, and 4K. In addition, the image forming portion includes a primary transfer roller 5: 5Y, 5M, 5C, and 5K, a laser scanner unit 3, a cleaning blade 7: 7Y, 7M, 7C, and 7K, an intermediate transfer unit 72, and an environmental sensor 71 (other temperature detecting portion) that detects a temperature/humidity.

The photosensitive drum 1 is an organic photosensitive layer formed at a thickness of about 30 to 60 μm on a surface layer of a conductor such as an aluminum cylinder. In the present embodiment, the photosensitive drum 1 is controlled to be driven at a circumferential speed of 180 mm/sec at the time of image formation.

The intermediate transfer unit 72 includes an intermediate transfer belt 51, a secondary transfer roller 14, a secondary transfer counter roller 15, a driving roller 17, a tension roller 61, and the like. The intermediate transfer belt 51 is an endless belt stretched around the secondary transfer counter roller 15, the driving roller 17, and the tension roller 61, and peripherally rotates according to the rotation of the driving roller 17.

Next, an image forming operation will be described. First, when a controller (not shown) receives an image forming job signal, a sheet S stacked and stored on a sheet stacking portion 62: 62a and 62b is sent out to a registration roller 10 by a feeding roller 9: 9a and 9b. Next, after skew feeding correction and timing correction are performed on the sheet S by the registration roller 10, front and rear end positions of the sheet S are detected by a top sensor 11, and the sheet S is sent to a secondary transfer portion formed by the secondary transfer roller 14 and the secondary transfer counter roller 15.

Meanwhile, in the image forming portion, the surface of the photosensitive drum 1 is uniformly charged by the charging roller 2. Then, the laser scanner unit 3 irradiates the surface of the photosensitive drum 1 of each color with a laser beam L: LY, LM, LC, and LK from a light source (not shown) depending on image data transmitted from an image reading portion 100, an external device (not shown) or the like to form an electrostatic latent image on the surface of the photosensitive drum 1.

Then, toners of each color are attached to the electrostatic latent image formed on the surface of the photosensitive drum 1 by the developing device 4 to form toner images on the surface of the photosensitive drum 1. The toner images formed on the surface of the photosensitive drum 1 are primarily transferred to the intermediate transfer belt 51, respectively, by applying a primary transfer bias to the primary transfer roller 5. As a result, a full-color toner image is formed on the surface of the intermediate transfer belt 51.

Then, the toner image is sent to the secondary transfer portion by peripherally rotating the intermediate transfer belt 51. The toner image on the intermediate transfer belt 51 is transferred to the sheet S by applying a secondary transfer bias to the secondary transfer roller 14 in the secondary transfer portion.

Next, the sheet S to which the toner image is transferred is subjected to heating and compressing processes in a fixing device 20, such that the toner image on the sheet S is fixed to the sheet S. Then, the sheet S to which the toner image is fixed is discharged to a discharge tray 21 by a discharge roller 16. The toners adhering to the surface of the photosensitive drum 1 after being primary transferred are scraped off and removed by the cleaning blade 7.

The image forming portion or the sheet stacking portion 62 is covered with an exterior cover. The exterior cover is provided in the image forming apparatus A in order to protect the image forming portion or the sheet stacking portion 62 and in order to allow the image forming portion or the sheet stacking portion 62 to not be visually recognized. The exterior cover includes a plurality of covers which is fixed to a body and an opening and closing door which is opened and closed for maintenance and jam recovery. Even though there is a slight gap between a plurality of adjacent covers and between the cover and the opening and closing door adjacent to the cover, the exterior cover approximately separates spatially the exterior and the interior of the image forming apparatus A from each other. For this reason, as described below, there is a case where a difference occurs between a temperature outside the image forming apparatus A and a temperature inside the image forming apparatus A. In the image forming apparatus A according to the present embodiment, a heater is not embedded in the image forming portion.

### <Management of Temperature and Dew Condensation Inside Apparatus>

Next, management of a temperature and dew condensation inside the image forming apparatus A will be described.

In the image forming apparatus A, a temperature inside the image forming apparatus becomes higher than that of outside air due to heat generated by the driving of various motors or a fixing operation of a fixing device 20 at the time of image formation. When the temperature inside the image forming apparatus rises as described above, for example, a temperature of a part of the photosensitive drum 1 which rubs against the cleaning blade 7 is further raised as much as the temperature rise to promote softening or fusing of the toner, such that the toner is easily adhered to the photosensitive drum 1.

Therefore, the image forming apparatus A includes intake ports 13 which are provided in the exterior of the body of the image forming apparatus and take in air, and ducts 95 which guide the air taken in from the intake ports 13 to the surroundings of each photosensitive drum 1. In addition, a fan 91 (duct fan) that generates an air flow for taking in the air from the intake port 13 and blows the air taken in the duct 95 toward the surroundings of the photosensitive drum 1 is provided inside the duct 95. The outside air is taken into the image forming apparatus A as described above to air-cool the heat generated from the fixing device 20, various motors, or the like, at the time of image formation, thereby suppressing the temperature rise inside the image forming apparatus.

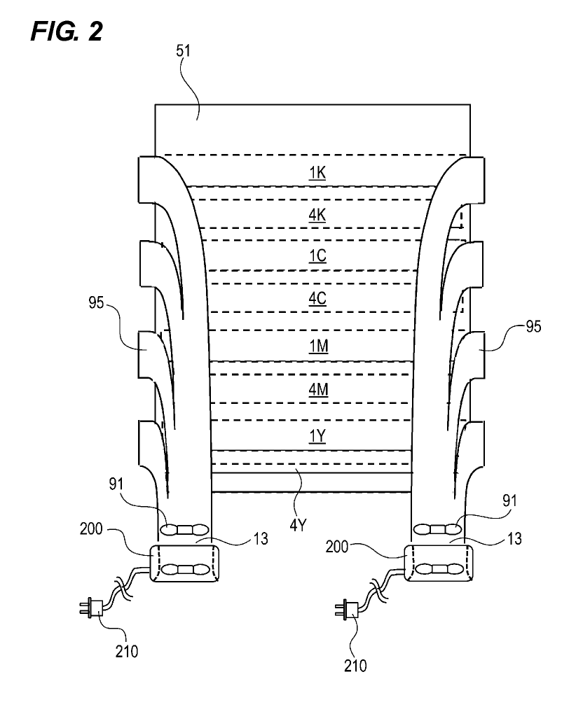

FIG. 2 is a schematic diagram showing an arrangement relationship between the fan 91 and the duct 95 of the image forming apparatus A. As shown in FIG. 2, one fan 91 and one duct 95 are disposed on each of both end parts of the photosensitive drum 1 in a rotational axis direction. As a result, the photosensitive drum 1 or the developing device 4 is air-cooled by the outside air blown from both end parts of the photosensitive drum 1 in the rotational axis direction. In addition, heater units 200 to be described below are attached in the vicinity of the intake ports 13 that take in the outside air, respectively. The heater unit 200 blows the air toward the intake port 13. The duct 95 is not limited to having a structure shown in FIG. 2, and may have any structure as long as warm air is guided to the vicinity of the photosensitive drum 1.

However, as described above, for example, in the case where power is applied to the image forming apparatus immediately after heating is operated after the image forming apparatus A is left in a state where heating of a room in which the image forming apparatus A is installed is stopped in winter in a cold district, dew condensation may occur in the image forming apparatus A due to warm air taken from the intake port 13 into the image forming apparatus A. Hereinafter, this dew condensation phenomenon will be described.

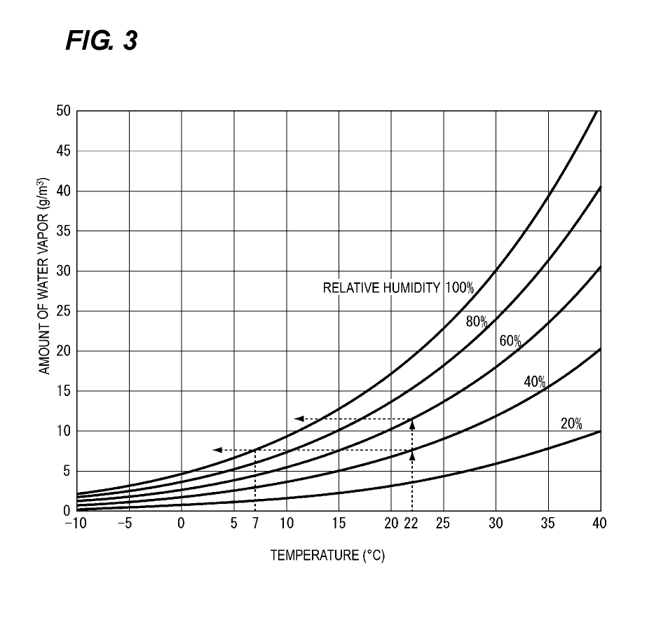

FIG. 3 is graphs showing relationships between a temperature (° C.) at a standard atmospheric pressure (1013.25 hPa) and an amount of water vapor (g/m³) contained in each atmosphere having a relative humidity of 100%, 80%, 60%, 40%, and 20%. As shown in FIG. 3, in the case where warm air of 22° C./40% RH is taken from the intake port 13 of the image forming apparatus A into the image forming apparatus A, since an amount of saturated water vapor at 7° C. is 7.76 g/m³ with respect to an amount (7.78 g/m³) of water vapor contained in this warm air, dew condensation occurs on a surface of an object of which a surface temperature is equal to or less than 7° C. That is, when this warm air is taken into the image forming apparatus A after the heating starts in winter, the dew condensation occurs when a surface temperature of the photosensitive drum 1 or the developing device 4 is 7° C. or less, such that uniform charging or uniform toner coating becomes difficult, resulting in an image defect. In addition, when a humidifier is operated together with an operation of a heating device in a state where a temperature in a room is low, the dew condensation easily occurs. That is, a humidity in the room rises due to the operation of the humidifier together with a rise in the temperature in the room due to the operation of the heating device, such that an amount of water vapor contained per 1 m³ is increased. In the case where this air is taken into the image forming apparatus A and the amount of water vapor contained per 1 m³ is larger than an amount of saturated water vapor in the image forming apparatus A, the dew condensation occurs.

In the present embodiment, it is assumed that a temperature/humidity of the warm air taken into the image forming apparatus A when the heating is operated in winter is 22° C./60% to 25° C./50%. In this case, an amount of water vapor contained in this warm air is about 11.5 g/m³. In addition, an amount of saturated water vapor at 15° C. is 12.85 g/m³. Therefore, the surroundings of the photosensitive drum 1 or the developing device 4 are maintained at about 15° C. by the heater unit 200 detachably attachable to the image forming apparatus A to suppress the dew condensation from occurring on the surface of the photosensitive drum 1 or the developing device 4.

### <Heater Unit>

Next, the heater unit 200 will be described. The heater unit 200 is an optional unit attached to the image forming apparatus A depending on an environment where the image forming apparatus A is installed.

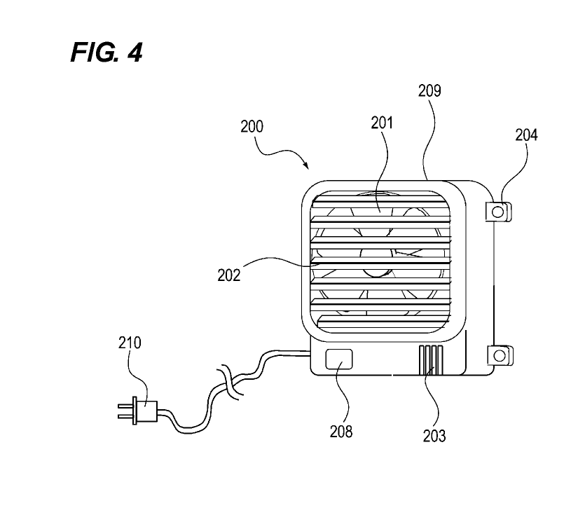

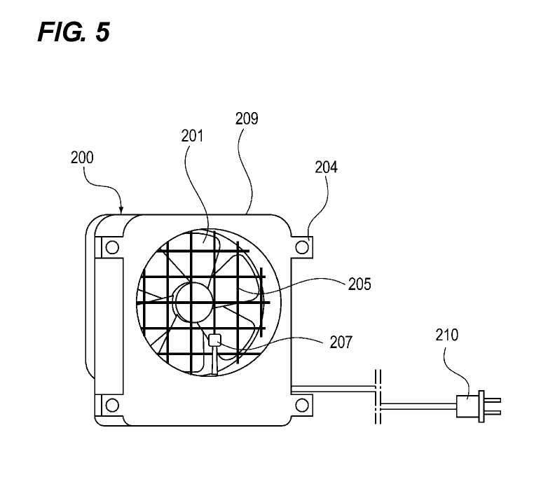

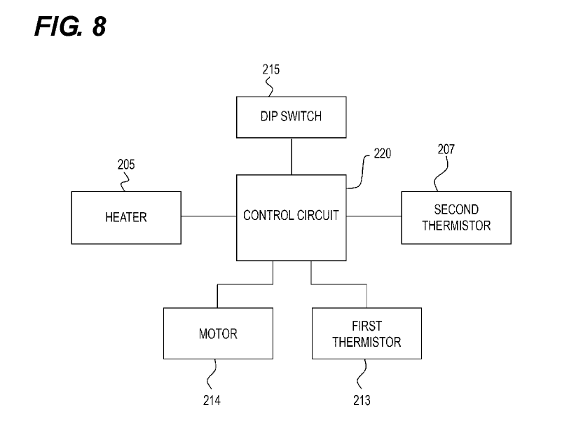

FIG. 4 is a perspective view of the heater unit 200 viewed from an intake side. FIG. 5 is a perspective view of the heater unit 200 viewed from an exhaust side. As shown in FIGS. 4 and 5, the heater unit 200 has a fan 201 and a louver 202 which protects the fan 201 or a user. In addition, a heater 205 energized to generate heat, such as a positive temperature coefficient (PTC) heater or a carbon heater, is provided on an exhaust side of the fan 201. In addition, the heater unit 200 is embedded with a motor 214 (see FIG. 8) which drives the fan 201.

In addition, a housing 209 of the heater unit 200 is provided with an air hole 203, a switch cover 208, and screwed portions 204 in which screw holes are formed. A first thermistor 213 (see FIG. 8) for detecting a temperature (ambient temperature) of outside air is provided inside the air hole 203. In addition, a second thermistor 207 for detecting an exhaust gas temperature P of air warmed by the heater 205 and exhausted from the heater unit 200 is provided on a downstream side of the heater 205 in a blowing direction of the fan 201.

In addition, the heater unit 200 has a power plug 210, and power is supplied by connecting the power plug 210 to a commercial power supply, such that the heater unit 200 can receive the power from the commercial power supply. That is, the power plug 210 corresponds to an insertion plug of an insertion connector for a wiring including the insertion plug and a plug receptacle. The power plug 210 is inserted into the plug receptacle provided on a wall or the like of a building. Due to this power, the heater 205 generates heat, and the fan 201 rotates. Therefore, the heater unit 200 is driven independently of the body of the image forming apparatus A.

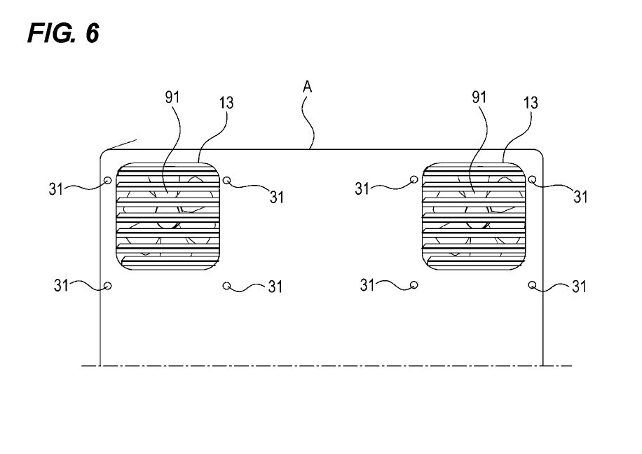

In addition, as shown in FIG. 6, screw holes 31 (mounted portions) are formed in parts of the intake port 13 of the exterior of the body of the image forming apparatus A. The heater unit 200 is screwed to the screw holes 31 through the screwed portions 204, and is mounted on the body of the image forming apparatus A. By mounting the heater unit 200 on the intake port 13 of the image forming apparatus A as described above, an air flow generated by the fan 201 included in the heater unit 200 flows into the intake port 13. Therefore, the air warmed by the heater 205 can be delivered up to the surroundings of the photosensitive drum 1 through the duct 95.

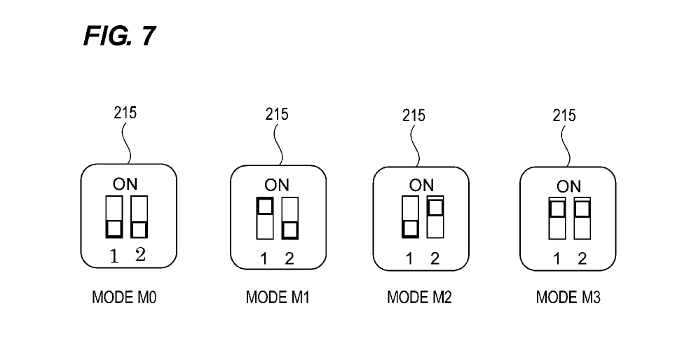

In addition, a DIP switch 215 and a control circuit 220 for selecting an operation mode of the heater unit 200 are embedded in the switch cover 208. FIG. 7 shows schematic diagrams of the DIP switch 215. As shown in FIG. 7, the DIP switch 215 is configured so that four operation modes of modes M0 to M3 can be selected by selecting ON/OFF. When the mode MO is selected, the heater unit 200 drives only the fan 201 in a state where the heater 205 is turned off. Operations when the modes M1 to M3 are selected will be described below.

### <Controller of Heater Unit>

Next, a system configuration of the heater unit 200 will be described.

FIG. 8 is a block diagram showing a system configuration of the heater unit 200. As shown in FIG. 8, the heater unit 200 has the control circuit 220, and the heater 205, the motor 214, the first thermistor 213, the second thermistor 207, and the DIP switch 215 are connected to the control circuit 220.

Each of the first thermistor 213 and the second thermistor 207 detects a temperature and outputs the detected temperature to the control circuit 220 (controller). The control circuit 220 controls the driving of the fan 201 through the motor 214 based on these temperature detection results, and also controls the driving of the heater 205.

In addition, the control circuit 220 changes the control as described below based on the selection of the operation mode by the DIP switch 215.

### <Operation Flow of Heater Unit>

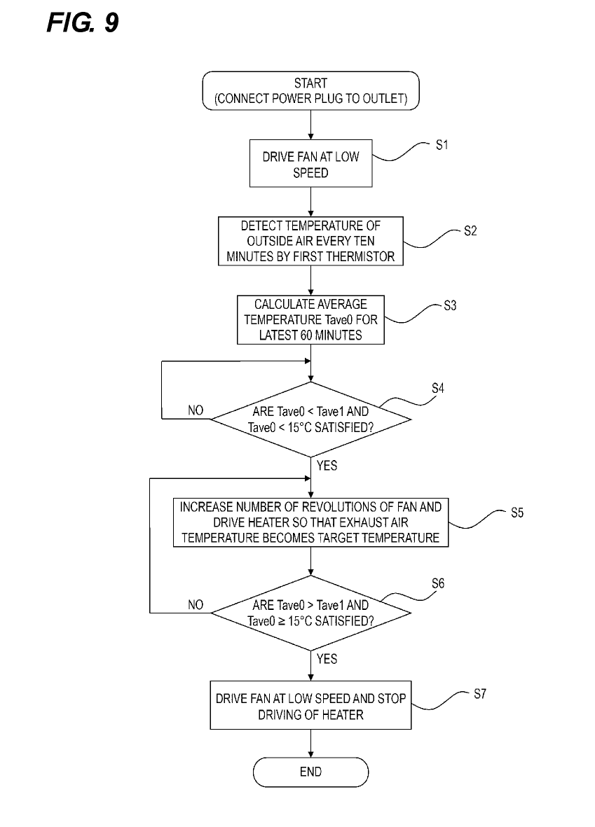

Next, an operation flow of the heater unit 200 will be described with reference to a flowchart shown in FIG. 9.

As shown in FIG. 9, first, when the power plug 210 of the heater unit 200 is inserted into an AC outlet of a commercial power supply, such that power is supplied, the control circuit 220 drives the motor 214 at a low speed to start low speed driving of the fan 201 (S1). In this case, the heater 205 is in an OFF state. Even though the heater 205 is in the OFF state as described above, by driving the fan 201, the outside air is easily taken into the image forming apparatus A even in the case where the heater unit 200 is disposed in the vicinity of the intake port 13 to become air resistance.

Then, the first thermistor 213 detects a temperature of the outside air every ten minutes (S2). In addition, the control circuit 220 calculates an average temperature Tave0 for the latest 60 minutes (S3) whenever the first thermistor 213 detects the temperature. Here, it is assumed that the latest temperature of the outside air detected by the first thermistor 213 is T0, a temperature of the outside air detected ten minutes ago is T1, a temperature of the outside air detected 20 minutes ago is T2, and temperatures of the outside air detected at an interval of 10 minutes before the 20 minutes are T3, T4, and T5. In this case, the average temperature Tave0 for the latest 60 minutes is calculated from the following equation 1:

$$Tave 0 = \frac{1}{7} \cdot {\sum }_{i = 0}^{6} T ( i ) . \qquad ( 1 )$$

Then, the control circuit 220 compares the average temperature Tave0 (first temperature) for the latest 60 minutes with an average temperature Tave1 (second temperature) for 60 minutes calculated 10 minutes ago to determine whether or not both of the following conditions 1 and 2 are satisfied (S4):

Tave0<Tave1 (1) and

Tave0<15° C. (2).

Then, when it is determined that both of the conditions 1 and 2 are satisfied, the control circuit 220 increases the number of revolutions of the fan 201, and controls the driving of the heater 205 so that the exhaust gas temperature P detected by the second thermistor 207 becomes a target temperature Ttag (S5). That is, when the average temperature Tave0 is lower than the average temperature Tave1 detected before and the average temperature Tave0 is lower than a predetermined temperature, the control circuit 220 drives the heater 205. In addition, the average temperature Tave0 and the average temperature Tave1 are average values of temperatures detected plural times by the first thermistor 213, respectively. In addition, the target temperature Ttag of the exhaust gas temperature P is set as follows depending on the operation mode selected by the DIP switch 215.

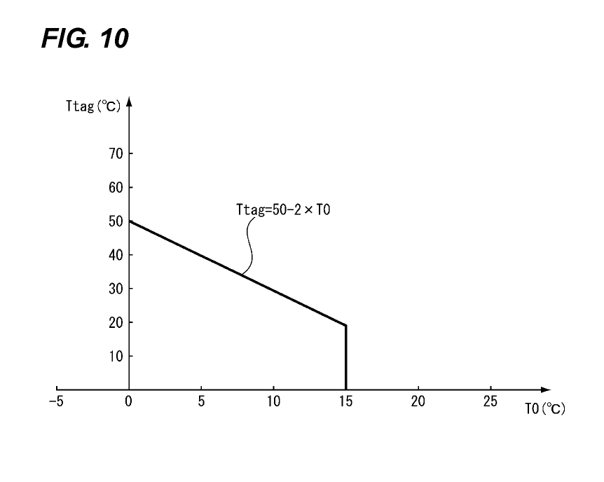

FIG. 10 is a graph showing a relationship between the target temperature Ttag of the exhaust gas temperature P and the latest temperature T0 of the outside air in the case where the mode M1 is selected by the DIP switch 215. As shown in FIG. 10, in the case where the mode M1 is selected, the driving of the heater 205 is controlled so that the target temperature becomes Ttag=50−2×T0 (0≤T0≤15).

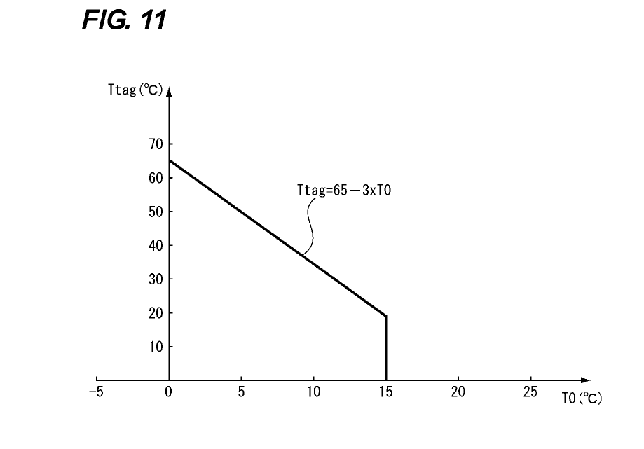

FIG. 11 is a graph showing a relationship between the target temperature Ttag of the exhaust gas temperature P and the latest temperature T0 of the outside air in the case where the mode M2 is selected by the DIP switch 215. As shown in FIG. 11, in the case where the mode M2 is selected, the driving of the heater 205 is controlled so that the target temperature becomes Ttag=65−3×T0 (0≤T0≤15).

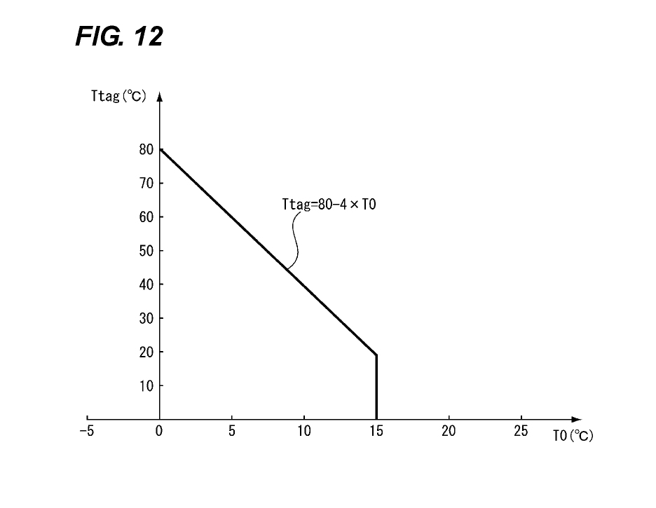

FIG. 12 is a graph showing a relationship between the target temperature Ttag of the exhaust gas temperature P and the latest temperature T0 of the outside air in the case where the mode M3 is selected by the DIP switch 215. As shown in FIG. 12, in the case where the mode M3 is selected, the driving of the heater 205 is controlled so that the target temperature becomes Ttag=80−4×T0 (0≤T0≤15).

The operation mode of the heater unit 200 as described above is selected by the user or a serviceman depending on an installation region, an outside air temperature/humidity of an installation environment, a situation of ventilation and convection, a sealing degree, and the like. That is, the DIP switch 215 is a selecting portion that selects the target temperature of the exhaust gas temperature P. In addition, default setting of the operation mode is set to the mode M2.

Then, the control circuit 220 continues to drive the heater 205 until the average temperature Tave0 for the latest 60 minutes calculated every 10 minutes from step S3 satisfies the following conditions 3 and 4 (S6). When the conditions 3 and 4 are satisfied, energization to the heater 205 is stopped to stop the driving of the heater 205, and the fan 201 is driven at a low speed (S7). That is, in the case where an average temperature Tave0 (third temperature) detected in a state where the heater 205 is driven is higher than an average temperature Tave1 (fourth temperature) detected before and the average temperature Tave0 is equal to or higher than a predetermined temperature, the control circuit 220 stops the driving of the heater 205.

Tave0>Tave1 (3)

Tave0≥15° C. (4)

As described above, the heater unit 200 is mounted on the intake port 13 of the image forming apparatus A, and sends the warm air to the intake port 13 by the air flow generated by the fan 201 to allow a temperature inside the image forming apparatus A to be maintained at about 15° C. even in an environment where the temperature of the outside air is less than 15° C. As a result, even in the case where a power supply of the image forming apparatus A is turned off in the winter night or the like or in the case where the image forming apparatus A is left in the winter night or the like, it is possible to suppress the dew condensation from occurring on the surface of the photosensitive drum 1, the developing device 4, or the like, such that it is possible to suppress an image defect due to the dew condensation without generating a downtime.

In addition, the heater unit 200 drives the heater 205 and the fan 201 based on the temperature of the outside air. As a result, power consumption can be suppressed as compared with a configuration in which the heater 205 is continuously driven.

In addition, since the heater unit 200 is configured to be detachably attachable to the body of the image forming apparatus A, in the case where a countermeasure against the dew condensation is not required, for example, in the case where the image forming apparatus is used in a region or a place where the countermeasure against the dew condensation is not required, the heater unit 200 cannot be mounted on the image forming apparatus A.

### Second Embodiment

Next, a second embodiment of an image forming apparatus on which a heater unit according to the present invention is mounted will be described with reference to the drawings. Parts overlapping those of the first embodiment are denoted by the same drawings and the same reference numerals, and a description thereof is omitted.

In the present embodiment, a heater unit 200 is configured to be operated in conjunction with a body of an image forming apparatus A. Here, a configuration according to the present embodiment will be described.

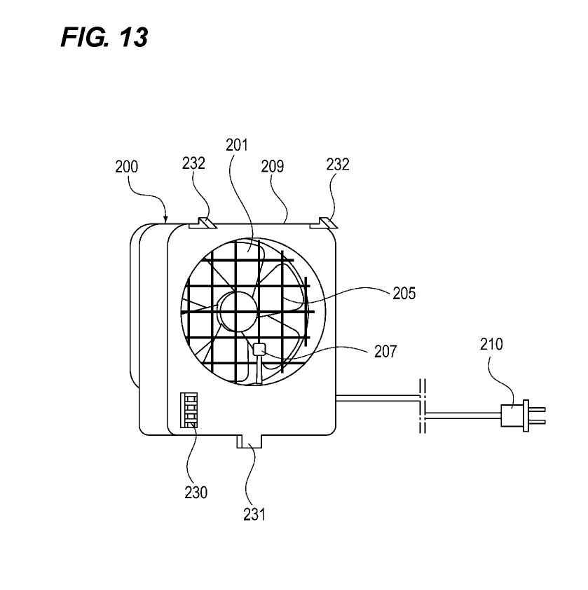

FIG. 13 is a perspective view of the heater unit 200 according to the present embodiment viewed from an exhaust side. As shown in FIG. 13, the heater unit 200 according to the present embodiment has a connector 230 as a communicating portion for performing data communication with the body of the image forming apparatus A. In addition, instead of the screwed portions 204, a protrusion 231 and projection portions 232 as engaging portions are formed as a mounting portion for the body of the image forming apparatus A in a housing 209. Other configurations are the same as those of the first embodiment.

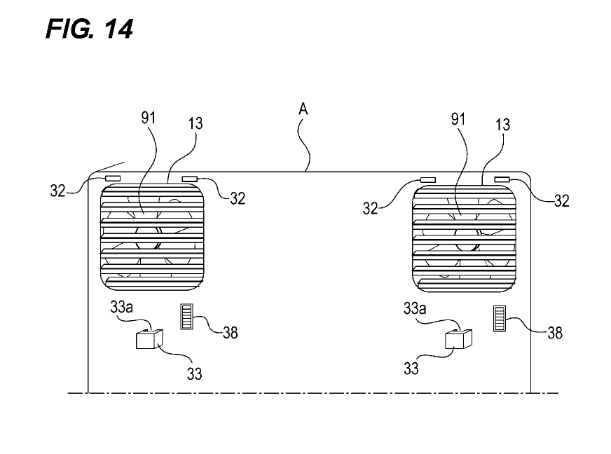

Here, the connector 230 can be connected to a connector 38 (see FIG. 14) provided in the body of the image forming apparatus A to communicate with the body of the image forming apparatus A through a direct current (DC) controller (not shown). A control circuit 220 receives information on a temperature detected by an environmental sensor 71 in the image forming apparatus A by the communication. An interface through which the heater unit 200 and the image forming apparatus A communicate with each other is not limited to a customized connector 230, and can also be a general-purpose interface such as a universal serial bus (USB) or institute of electrical and electronics engineers (IEEE) 1394.

In addition, in the present embodiment, as shown in FIG. 14, insertion ports 32 (mounted portions or engaged portions) into which the projection portions 232 are inserted and engaged are formed in a part of an intake port 13 of the exterior of the body of the image forming apparatus A. In addition, an insertion hook 33 having an insertion port 33a (a mounted portion or an engaged portion) into which the protrusion 231 is inserted and engaged is formed. The projection portions 232 (engaging portions) are engaged with the insertion ports 32, and the protrusion 231 (engaging portion) is engaged with the insertion port 33a, such that the heater unit 200 is mounted on the body of the image forming apparatus A. As a result, the heater unit 200 can be mounted on the body of the image forming apparatus A in a one-touch manner without being screwed to the body of the image forming apparatus A. By mounting the heater unit 200 on the intake port 13 of the image forming apparatus A as described above, an air flow generated by a fan 201 included in the heater unit 200 flows into the intake port 13. Therefore, air warmed by a heater 205 can be delivered up to the surroundings of a photosensitive drum 1 through a duct 95.

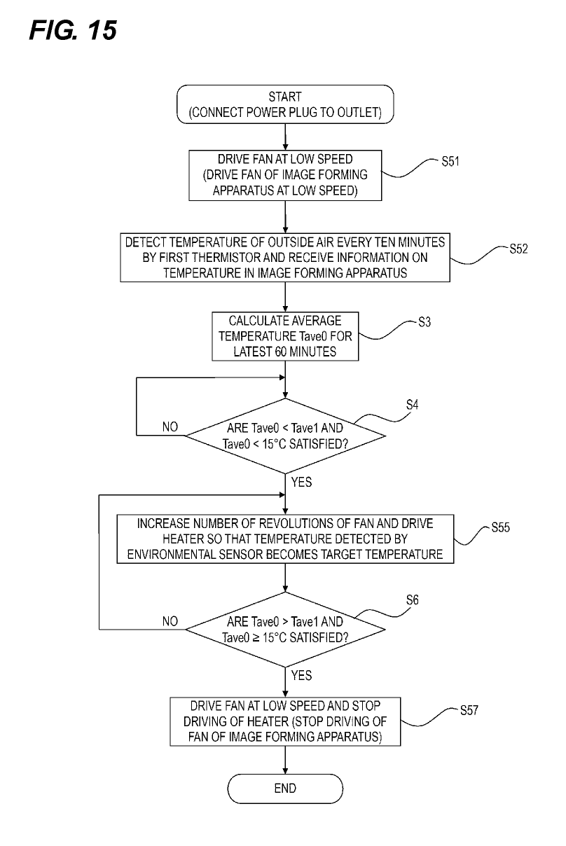

Next, an operation flow of the heater unit 200 according to the present embodiment will be described with reference to a flowchart shown in FIG. 15. In the following description, processes that perform the same processing as that of the processes described with reference to FIG. 9 in the first embodiment will be denoted by the same reference numeral, and a description thereof will be omitted or simplified.

As shown in FIG. 15, first, when a power plug 210 of the heater unit 200 is inserted into an AC outlet of a commercial power supply, such that power is supplied, the control circuit 220 drives a motor 214 at a low speed to start low speed driving of the fan 201 (S51).

In this case, the body of the image forming apparatus A detects that a power supply of the heater unit 200 is turned on by the communication between the heater unit 200 and the body of the image forming apparatus A. In addition, a controller (not shown) of the body of the image forming apparatus A starts driving of a fan 91 disposed in the duct 95 when it is detected that the power supply of the heater unit 200 is turned on. That is, the fan 201 and the fan 91 are driven in conjunction with each other. When the power supply of the heater unit 200 is turned on, the image forming apparatus A communicates with the heater unit 200, and is thus set so as not to transit to a sleep mode.

Then, a first thermistor 213 detects a temperature of the outside air every ten minutes. In addition, the heater unit 200 receives the information on the temperature detected by the environmental sensor 71 of the image forming apparatus A from the image forming apparatus A by communication (S52). In addition, the control circuit 220 calculates an average temperature Tave0 for the latest 60 minutes (S3) whenever the first thermistor 213 detects the temperature.

Then, the control circuit 220 compares the average temperature Tave0 for the latest 60 minutes with an average temperature Tave1 for 60 minutes calculated 10 minutes ago to determine whether or not both of the above conditions 1 and 2 are satisfied (S4).

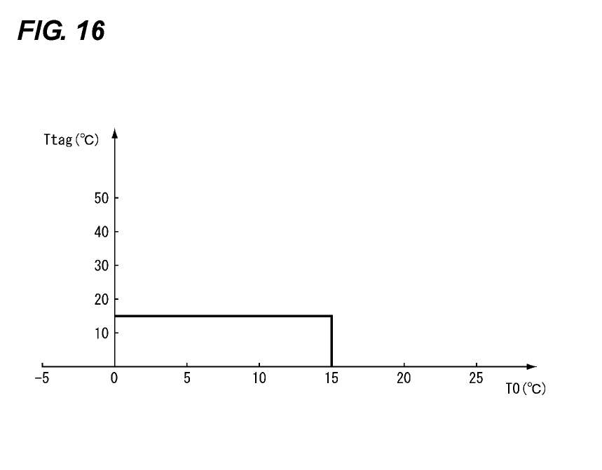

Then, when it is determined that both of the conditions 1 and 2 are satisfied, the control circuit 220 increases the number of revolutions of the fan 201, and controls driving of the heater 205 so that the temperature detected by the environmental sensor 71 becomes a target temperature Ttag (S55). Here, the target temperature Ttag is set depending on an operation mode selected by a DIP switch 215. In the present embodiment, a mode M2 is selected, and as shown in FIG. 16, the target temperature Ttag is set to 15° C. The target temperature Ttag of a mode M1 is set to be lower than the target temperature Ttag of the mode M2, and the target temperature Ttag of a mode M3 is set to be higher than the target temperature Ttag of the mode M2. In addition, in this case, the controller (not shown) of the body of the image forming apparatus A drives the fan 91 in the duct 95 at a high speed so as to be operated in conjunction with the fan 201 of the heater unit 200.

Then, the control circuit 220 continues to drive the heater 205 until the average temperature Tave0 for the latest 60 minutes calculated every 10 minutes from step S3 satisfies the above conditions 3 and 4 (S6). When the conditions 3 and 4 are satisfied, energization to the heater 205 is stopped to stop the driving of the heater 205, and the fan 201 is driven at a low speed (S57). In this case, the controller (not shown) of the image forming apparatus A stops the driving of the fan 91 in conjunction with this.

As described above, in the present embodiment, the communication is performed between the image forming apparatus A and the heater unit 200, and the driving of the heater 205 and the fan 201 is controlled so that the temperature detected by the environmental sensor 71 in the image forming apparatus A becomes the target temperature Ttag. As a result, in the case where dew condensation occurs, it is possible to allow a temperature in the vicinity of a member such as the photosensitive drum 1 or the like, which has a large influence on a quality of an image, to become a desired temperature, such that it is possible to take a countermeasure against the dew condensation with higher accuracy or reliability.

In addition, the image forming apparatus A in which the heater is not embedded in the image forming portion has been described by way of example in the first embodiment and the second embodiment, but the heater may also be embedded in the image forming portion. For example, in the case where the image forming apparatus A is used in an environment more severe than an assumed environment even though a heater for preventing the dew condensation is embedded in the image forming apparatus A, it is assumed that it takes much time to raise a temperature inside the image forming apparatus A to a temperature at which the dew condensation does not occur with only the embedded heater. Therefore, the heater unit 200 may be installed and used on the image forming apparatus A so as to complement the embedded heater.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-010781, filed Jan. 25, 2018, which is hereby incorporated by reference herein in its entirety.

What is claimed is:

1. A heater unit detachably attachable to an image forming apparatus, the image forming apparatus including an image forming portion configured to form an image by transferring a toner image formed on a surface of a photoreceptor to a recording material, an intake port configured to be provided in an exterior of a body of the image forming apparatus, a duct configured to guide air taken in from the intake port to the surroundings of the photoreceptor, and a duct fan configured to generate an air flow for taking air from the intake port into the duct, the heater unit comprising:
a power plug configured to receive power from a commercial power supply;
a heater configured to generate heat by the power received from the power plug;
a fan configured to rotate by the power received from the power plug and blow air warmed by the heater; and
a screw hole configured to fix the heater unit to the image forming apparatus by a screw,
wherein the heater unit is configured to be mounted on the intake port so that an air flow generated by the fan of the heater unit flows into the intake port.

2. The heater unit according to claim 1, further comprising:
a temperature detecting portion configured to detect a temperature; and
a controller configured to control driving of the heater depending on a detection result of the temperature detecting portion.

3. The heater unit according to claim 2, wherein the controller drives the heater when a first temperature detected by the temperature detecting portion is lower than a second temperature detected before the first temperature and is lower than the predetermined temperature.

4. The heater unit according to claim 3, wherein the controller stops the driving of the heater when a third temperature detected by the temperature detecting portion is higher than a fourth temperature detected before the third temperature and is equal to or higher than the predetermined temperature in a state where the heater is driven.

5. The heater unit according to claim 4, wherein the first temperature, the second temperature, the third temperature, and the fourth temperature are average values of temperatures detected plural times by the temperature detecting portion, respectively.

6. The heater unit according to claim 2, further comprising another temperature detecting portion configured to be provided on a downstream side of the heater in a blowing direction of the fan included in the heater unit and detect a temperature of air warmed by the heater,
wherein the controller controls driving of the heater such that a temperature detected by another temperature detecting portion becomes a target temperature.

7. The heater unit according to claim 2, further comprising a communicating portion configured to receive information on a temperature inside the image forming apparatus by communication with the image forming apparatus,
wherein the controller controls the heater such that the temperature inside the image forming apparatus received by the communicating portion becomes a target temperature.

8. The heater unit according to claim 6, further comprising a selecting portion configured to select the target temperature.

9. The heater unit according to claim 2, wherein the controller controls driving of the fan included in the heater unit to increase the number of revolutions of the fan included in the heater unit when the controller drives the heater as compared with when the controller does not drive the heater.

10. A heater unit detachably attachable to an image forming apparatus, the image forming apparatus including an image forming portion configured to form an image by transferring a toner image formed on a surface of a photoreceptor to a recording material, an intake port configured to be provided in an exterior of a body of the image forming apparatus, a duct configured to guide air taken in from the intake port to the surroundings of the photoreceptor, and a duct fan configured to generate an air flow for taking air from the intake port into the duct, the heater unit comprising:
a power plug configured to receive power from a commercial power supply;
a heater configured to generate heat by the power received from the power plug;
a fan configured to rotate by the power received from the power plug and blow air warmed by the heater; and
an engaging portion configured to be engaged with the image forming apparatus,
wherein the heater unit is configured to be mounted on the intake port so that an air flow generated by the fan of the heater unit flows into the intake port.

11. The heater unit according to claim 10, further comprising:
a temperature detecting portion configured to detect a temperature; and
a controller configured to control driving of the heater depending on a detection result of the temperature detecting portion.

12. The heater unit according to claim 11, wherein the controller drives the heater when a first temperature detected by the temperature detecting portion is lower than a second temperature detected before the first temperature and is lower than the predetermined temperature.

13. The heater unit according to claim 12, wherein the controller stops the driving of the heater when a third temperature detected by the temperature detecting portion is higher than a fourth temperature detected before the third temperature and is equal to or higher than the predetermined temperature in a state where the heater is driven.

14. The heater unit according to claim 13, wherein the first temperature, the second temperature, the third temperature, and the fourth temperature are average values of temperatures detected plural times by the temperature detecting portion, respectively.

15. The heater unit according to claim 11, further comprising another temperature detecting portion configured to be provided on a downstream side of the heater in a blowing direction of the fan included in the heater unit and detect a temperature of air warmed by the heater,
wherein the controller controls driving of the heater such that a temperature detected by another temperature detecting portion becomes a target temperature.

16. The heater unit according to claim 11, further comprising a communicating portion configured to receive information on a temperature inside the image forming apparatus by communication with the image forming apparatus,
wherein the controller controls the heater such that the temperature inside the image forming apparatus received by the communicating portion becomes a target temperature.

17. The heater unit according to claim 15, further comprising a selecting portion configured to select the target temperature.

18. The heater unit according to claim 11, wherein the controller controls driving of the fan included in the heater unit to increase the number of revolutions of the fan included in the heater unit when the controller drives the heater as compared with when the controller does not drive the heater.

19. An image forming apparatus comprising:
an image forming portion configured to form an image by transferring a toner image formed on a surface of a photoreceptor to a recording material;
an intake port configured to be provided in an exterior of a body of the image forming apparatus;
a duct configured to guide air taken in from the intake port to the surroundings of the photoreceptor;
a duct fan configured to generate an air flow for taking air from the intake port into the duct;
a heater unit; and
a screw hole configured to be provided in the body of the image forming apparatus in order to fix the heater unit by a screw,
wherein the heat unit includes:
a power plug configured to receive power from a commercial power supply;
a heater configured to generate heat by the power received from the power plug;
a fan configured to rotate by the power received from the power plug and blow air warmed by the heater; and
a screw hole configured to fix the heater unit to the body of the image forming apparatus by the screw,
the heater unit being configured to be mounted on the intake port so that an air flow generated by the fan of the heater unit flows into the intake port.

20. The image forming apparatus according to claim 19, wherein the duct fan included in the image forming apparatus and the fan included in the heater unit are driven in conjunction with each other.

21. An image forming apparatus comprising:
an image forming portion configured to form an image by transferring a toner image formed on a surface of a photoreceptor to a recording material;
an intake port configured to be provided in an exterior of a body of the image forming apparatus;
a duct configured to guide air taken in from the intake port to the surroundings of the photoreceptor;
a duct fan configured to generate an air flow for taking air from the intake port into the duct;
a heater unit; and
an engaged portion with which the heater unit is engaged,
wherein the heat unit includes:
a power plug configured to receive power from a commercial power supply;
a heater configured to generate heat by the power received from the power plug;
a fan configured to rotate by the power received from the power plug and blow air warmed by the heater; and
an engaging portion configured to be engaged with the engaged portion,
the heater unit being configured to be mounted on the intake port so that an air flow generated by the fan of the heater unit flows into the intake port.

22. The image forming apparatus according to claim 21, wherein the duct fan included in the image forming apparatus and the fan included in the heater unit are driven in conjunction with each other.
